(19) United States
(12) Patent Application Publication
(10) Pub. No.: US 2002/0040650 A1
(43) Pub. Date: Apr. 11, 2002

(54) Adjustable stamper

(75) Inventor: Darryl L. Kaminski, Greendale, WI (US)

Correspondence Address: Todd A. Rathe, FOLEY & LARDNER, Firstar Center, 777 East Wisconsin Avenue, Milwaukee, WI, 53202-5367, US

(73) Assignee: Newell Operating Company

(21) Appl. No.: 09/974,467

(22) Filed: Oct. 10, 2001

Related U.S. Application Data
(60) Provisional application No. 60/238,932, filed on Oct. 10, 2000.

(51) Int. Cl. B41F 1/00; B41F 31/00

(52) U.S. Cl. 101/368

(57) ABSTRACT

A stamper system includes a support and a pattern-forming member. The pattern forming member includes an expanse and a plurality of distinct design portions coupled to the expanse at spaced locations. The expanse is movable relative to the support to enable simultaneous repositioning of the plurality of distinct design portions relative to the support by movement of the expanse.

### CROSS-REFERENCE TO RELATED PATENT APPLICATIONS

This application claims priority under 35 U.S.C. §119(e) from U.S. Provisional Patent Application Serial No. 60/238,932 entitled PAINT ACCESSORIES INCLUDING PAINT ROLLER and filed on Oct. 10, 2000 by Brian E. Woodnorth, Christina L. Fortner and Darryl L. Kaminski, the full disclosure of which is hereby incorporated by reference.

### FIELD OF THE INVENTION

The subject matter of the invention generally relates to stamping pads such as those used to place patterns along borders or edges of walls and other surfaces.

### BACKGROUND

Stamping pads are commonly employed to imprint liquid coatings along a wall or other surface to create a continuous border having a desired pattern of designs. Such stamping pads typically include a generally rigid flat base having a handle on one side and carrying a foam or sponge material. The sponge material is configured to carry liquid coating and is shaped or embossed to create a positive or a negative imprint of a design on the surface. In use, the foam or sponge material is dipped or otherwise loaded with paint and is then pressed against the wall surface to create a pattern or design on the wall surface. In many applications, this process is repeated along the entire length of each of the walls bounding a room.

Although well suited for forming patterns along the general length of each wall, such conventional stamping pads are generally incapable of producing uniformly spaced symmetrical patterns of design about an entire room. Because the base supporting the foam or sponge material is generally rigid, and because the foam or sponge material is generally fixed to the base at a predetermined distance from the edges of the base, the sponge or foam material must also be imprinted on the wall at the same distance spaced from the corner joining two adjacent walls. In many applications, the length of the wall and the spacing of the design may require that the design be imprinted on the wall at a location closer to the corner than permitted by the fixed distance between the foam or sponge material and the edge of the base. As a result, the imprinted designs adjacent the corners of the wall must either be omitted, creating a large unsymmetrical gap in the pattern, or must be imprinted closer to the preceding design of the pattern, resulting in a bunched up, unsymmetrical pattern.

In an attempt to provide a stamping pad capable of producing symmetrical patterns along a surface such as along the top of the walls of a room, a stamper has been developed that includes a base having a first portion of a hook and loop fastener (commonly known as Velcro®) and individual paint-applying members provided with the second portion of the hook and loop fastener. To ensure a symmetrical pattern, each paint-applying member may be separated from the backing and repositioned relative to the edge of the base. Although enabling the paint-applying members to be repositioned relative to the edges of the base, this system presents several problems. In particular, achieving a symmetrical pattern along the surface requires that the paint-applying members be repositioned upon the base in exactly the same position relative to one another and relative to two of the four sides when being adjusted relative to the other two of the four sides. Because of this requirement, the base of such systems are typically provided with a grid. Although the provision of a grid is helpful, repositioning such paint-applying members in precisely the correct locations on the base is tedious, time consuming and prone to error. Moreover, during use of such systems, paint frequently becomes embedded or retained within the hook and loop fastener materials, resulting in paint accidentally being deposited upon the surface being stamped and making clean up difficult.

Thus, there is a continuing need for a stamping pad that has paint applying portions that are easy to adjust relative to a base, that produces consistent symmetrical patterns, and that is easy to clean.

### SUMMARY OF THE INVENTION

According to one exemplary embodiment, a stamper system includes a support and a pattern-forming member. The pattern forming member includes an expanse and a plurality of distinct design portions coupled to the expanse at spaced locations. The expanse is movable relative to the support to enable simultaneous repositioning of the plurality of distinct design portions relative to the support by movement of the expanse.

According to another exemplary embodiment, the stamper system includes a support and a design portion movably coupled to the support. The design portion is movable relative to the support while remaining coupled to the support.

According to yet another exemplary embodiment, a pattern-forming member for use with a support is provided. The pattern-forming member includes an expanse and a plurality of distinct design portions coupled to the expanse at spaced locations. The expanse is adapted to be movably coupled relative to the support to enable simultaneous repositioning of the plurality of distinct design portions.

### BRIEF DESCRIPTION OF THE DRAWINGS

FIG. 1 is a bottom plan view of a stamper system of the present invention.

FIG. 2 is an end elevational view of the stamper system of FIG. 1.

FIG. 3 is a top plan view of the stamper system of FIG. 1.

FIG. 4 is an end elevational view of an alternative embodiment of the stamper system of FIG. 1.

FIG. 5 is a top plan view of the stamper system of FIG. 4.

### DETAILED DESCRIPTION OF THE PREFERRED EMBODIMENTS

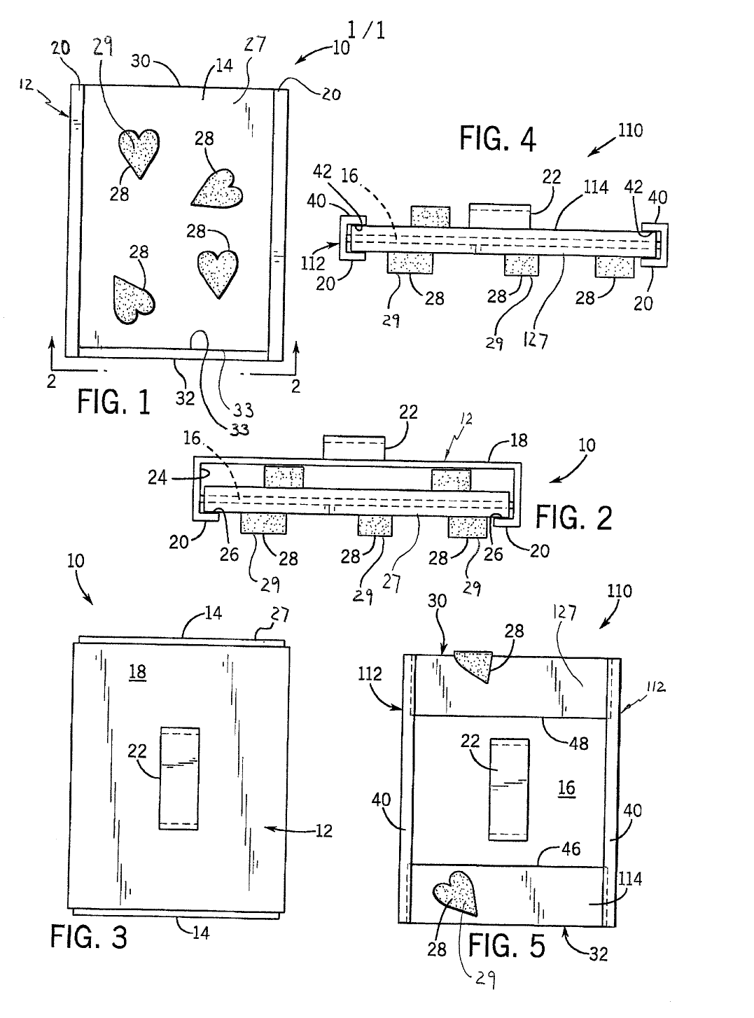

FIGS. 1-3 illustrate adjustable stamper system 10. As shown by FIGS. 1-3, collectively, stamper system 10 includes support 12 and pattern-forming member 14. Support 12 adjustably supports pattern-forming member 14 and generally includes lower base 16, upper base 18, guides 20 and handle 22. Lower base 16 comprises a rigid generally flat member configured to abut and maintain pattern-forming member 14 against a surface. Lower base 16 extends opposite to upper base 18. Upper base 18 cooperates with lower base 16 to form a channel 24 through which pattern-forming member 14 extends. Upper base 18 further supports handle 22.

Handle 22 is secured to or integrally formed as part of upper base 18 and is configured to allow a user to easily grasp stamper system 10.

Guides 20 extend from opposite sides of lower base 16 and are configured to receive and guide movement of pattern-forming member 14 relative to lower base 16. In the exemplary embodiment, guides 20 comprise inwardly extending flanges configured to form inwardly facing channels 26 that receive the edges of pattern-forming member 14 to capture pattern-forming member 14 against lower support 16.

Pattern-forming member 14 generally includes an expanse 27 and design portions 28. Expanse 27 comprises a support or base movably coupled to support 12 while carrying and interconnecting the plurality of design portions 28. As a result, design portions 28 may be simultaneously repositioned relative to support 28 by mere movement of expanse 27. Expanse 27 is movable relative to support 12, while remaining coupled to support 12. In the exemplary embodiment illustrated, expanse 27 comprises an elongate flexible endless belt encircling lower support 16 such that it extends through channel 24 and such that it extends below lower support 16 between lower support 16 and guides 20. Movement of expanse 27 relative to support 12 requires that expanse 27 be rotated and slid relative to support 12. Although not illustrated, additional bearings or low friction surfaces may be provided on either of expanse 27 or support 12 to facilitate movement of expanse 27 relative to support 12.

Design portions 28 are coupled to expanse 27 and are configured to deposit or apply a liquid coating in a desired shape or design to a surface being stamped or coated. In the exemplary embodiment, design portions 28 comprise a plurality of relatively raised portions 28 in desired shapes. Portions 28 are preferably formed from a paint or liquid absorbing and releasing material such as foam, fabric nap, sponge or other materials. Alternatively, raised portions 28 are alternatively formed from materials such as rubber, plastic and the like. Although illustrated as being fixedly or permanently coupled to expanse 27, design portions 28 may alternatively be removably coupled to expanse 27 to facilitate the use of different design portions having different shapes and sizes with support 12 and expanse 27. As shown by FIG. 2, each design portion has a liquid applying surface 29 configured to be pressed against the surface being coated and to form the design thereon. The liquid applying surfaces 29 of design portions 28 preferably extend in a common flat plane so as to simultaneously form designs upon the surface being coated or stamped.

In the exemplary embodiment, support 12 and expanse 27 are configured to enable pattern-forming member 14 to be removed or separated from support 12. Expanse 27 preferably has longitudinal ends 33 which are releasably attachable to one another such that when ends 33 are connected, expanse 27 is in the form of an endless belt. Preferably, ends 33 are connected by a conventionally known or future developed fastening mechanism located at one or both of longitudinal ends 33, such as a hook and loop fastener mechanism, snaps, pins, buttons, hooks, zippers and the like. In alternative embodiments, support 12 may be configured to facilitate removal of expanse 27. For example, support 12 may be configured to enable the endless belt provided by expanse 27 to be removed from about base 16 in a sideways transverse direction. In one alternative embodiment, portions of support 12 may pivot or be configured to be separated from base 16 to facilitate removal of pattern-forming member 14. Overall, because pattern-forming member 14 is removably coupled to support 12, pattern-forming member 14 may be easily separated from support 12 for cleaning, repair, modification or replacement.

In use, portions 28 are loaded with a liquid coating such as paint and are pressed against a wall or other surface sequentially to form a series or a pattern of designs in the shape of portions 28 along the surface. At each corner, the pattern-forming member 14 is slid or rolled relative to support 12 so as to appropriately position selected raised portions 28 at a desired distance from either of edges 30, 32 of support 12 such that the same uniform spacing of designs can be applied to the wall or other surface proximate the corner. Once the pattern of designs 28 has been formed proximate the corner, the belt forming pattern-forming member 14 is returned to its initial position and the adjacent wall is stamped. Although pattern-forming member 14 is illustrated as including relatively raised portions 28 which form a positive impression upon a wall or other surface, designs 28 may alternatively comprise depressions or embossments in a large surface of liquid applying material such as foam, fabric nap or the like such that the depressed portions 28 form negative impressions or designs on a wall or other surface.

FIGS. 4 and 5 illustrate stamper system 110, an alternative embodiment of stamper system 10 shown in FIGS. 1-3. Stamper system 110 is similar to stamper system 10 in that it enables imprinting of designs in the shape of portions 28 at a uniform spacing along a wall including corners between adjacent walls. For ease of illustration, those components or elements of stamper system 110 which are similar to stamper system 10 are numbered similarly. As shown by FIG. 4, stamper system 110 includes support 112 and pattern-forming member 114. Support 112 is similar to support 12 except that support 112 omits upper base 18 and includes guides 40. Guides 40 extend along the opposite edges of lower base 16 to form opposing inwardly facing channels 42 configured to receive the opposite edges of pattern-forming member 114. As shown by FIG. 5, handle 22 is directly affixed to lower base 16.

Pattern-forming member 114 is similar to pattern-forming member 14 except that pattern-forming member 114 comprises an elongate flexible band or expanse 127 of material having opposite longitudinal ends 46, 48. As best shown by FIG. 5, opposite ends 46 and 48 of expanse 127 remain spaced from one another and are not interconnected to one another. Rather, ends 46 or 48 are simply folded about edges of base 16 and captured base 16 and guides 40. Removal of pattern-forming member 114 simply requires that ends 46 and 48 be slidably withdrawn from between base 16 and guides 40, and that pattern-forming member 114 be slidably withdrawn from lower guides 20 for cleaning, replacement, modification or repair. In alternative embodiments, lower guide 20 may be omitted. Moreover, guides 20 and 40 may be omitted where alternative means are provided for releasably retaining pattern-forming member 114 in place relative to support 112.

Expanse 127 is preferably formed from a flexible material such as fabric, rubber or an elastomeric plastic. The material chosen for expanse 127 should preferably be sufficiently flexible so as to enable expanse 127 to be bent or folded relative to itself such that portions of expanse 127 are capable of extending in substantially parallel planes. Although less desirable, expanse 127 may alternatively be formed from a material which is deformable, such as paper and the like, wherein the paper expanse 127 may be folded or bent to facilitate it being wrapped about base 116. Expanse 127 carries designs 28 which are preferably relatively raised portions of liquid-absorbing and releasing material such as foam, sponge or fabric nap. As discussed above, alternatively, designs 28 may be made out of non-paint absorbing material such as rubber or the like or it may comprise negative impressions in the material.

In use, designs 28 are loaded with a liquid coating pressed against a wall or other surface into imprint designs upon the wall. The process is continued along the wall to form a pattern of designs 28 which are uniformly spaced relative to one another. At corners joining adjacent walls, ends 46 and 48 are moved relative to support 112 to appropriately position the particular designs 28 at a desired spacing from edges 30, 32 of support 112. Portions of pattern-forming member 114 are simply folded over and about the edges of lower base 16 as necessary. If desired, additional clips may be provided for the retaining edges 46 and 48 in place against support 112 in a desired position relative to support 112.

Overall, stamper systems 10 and 110 provide a stamping pad that has paint or liquid coating applying portions that are easy to adjust relative to the base, that produce consistent symmetrical patterns and that are easy to clean. In particular, stamper systems 10 and 110 enable a plurality of distinct spaced design portions to be simultaneously repositioned relative to one or more edges of the pad support by movement of a common expanse which interconnects each of the design portions. Stamper systems 10 and 110 further enable a design portion to be moved and repositioned relative to the support while remaining coupled to the support. As a result, accurate repositioning of even a single design portion is better facilitated.

What is claimed is:

1. A stamper system comprising:
a support; and
a pattern-forming member including:
an expanse movably coupled to the support; and
a plurality of distinct designed portions coupled to the expanse at spaced locations, wherein the expanse is movable relative to the support to enable simultaneous repositioning of the plurality of distinct design portions relative to the support by movement of the expanse.

2. The system of claim 1, wherein the expanse is movable relative to the support while remaining coupled to the support.

3. The system of claim 2, wherein the expanse slides relative to the support.

4. The system of claim 2, wherein each of the plurality of design portions has a liquid applying surface and wherein the liquid applying surfaces extend in a common flat plane.

5. The system of claim 1, wherein the expanse is removably coupled to the support.

6. The system of claim 1, wherein the expanse is flexible.

7. The system of claim 1, wherein the expanse is endless.

8. The system of claim 6, wherein the expanse comprises a belt.

9. The system of claim 1, wherein the plurality of design portions include at least one paint absorbing and releasing material.

10. The system of claim 9, wherein the paint absorbing and releasing material is selected from the group including: fabric, foam, hair and sponge.

11. The system of claim 1, wherein the support includes a handle.

12. The system of claim 1, wherein the support includes a first base extending against the expanse.

13. The system of claim 11 including at least one first guide coupled to the first base and configured to guide movement of the expanse relative to a first side of the first base.

14. The system of claim 13, wherein the at least one first guide includes a pair of opposing guides receiving the expanse therebetween.

15. The system of claim 12 including at least one second guide coupled to the first base and configured to guide movement of the expanse relative to a second side of the first base.

16. The system of claim 12 including a second base coupled to the first base, wherein the first base and the second base form a channel therebetween and wherein the expanse extends through the channel.

17. The system of claim 12, wherein the first base has a first side, a second side and an edge therebetween, and wherein the expanse extends along the first side, the edge and the second side.

18. The system of claim 1, wherein the plurality of design portions are fixedly coupled to the expanse.

19. The system of claim 1, wherein the plurality of design portions comprise raised portions projecting beyond the expanse.

20. The system of claim 1, wherein the expanse is movable in a longitudinal direction relative to the support and wherein the expanse has first and second opposite longitudinal ends.

21. A stamper system comprising:
a support; and
a first design portion movably coupled to the support,
wherein the first design portion is movable relative to the support while remaining coupled to the support.

22. The system of claim 21 including an expanse coupled to the first design portion and movably coupled to the support.

23. The system of claim 22 including a second design portion coupled to the expanse and spaced from the first design portion.

24. The system of claim 23, wherein the first design portion has a first design forming surface, wherein the second design portion has a second design forming surface, and wherein the first and second design forming surfaces extend in a common flat plane.

25. The system of claim 22, wherein the expanse is flexible.

26. The system of claim 25, wherein the expanse extends in two substantially parallel planes.

27. The system of claim 22, wherein the first design portion is fixedly coupled to the expanse.

28. The system of claim 21, wherein the expanse is endless.

29. The system of claim 21, wherein the first design portion is slidably coupled to the support.

30. The system of claim 21, wherein the first design portion includes a paint absorbing and releasing material.

31. A pattern-forming member for use with a support, the member comprising:
a expanse; and
a plurality of distinct design portions coupled to the expanse at spaced locations, wherein the expanse is adapted to be movably coupled relative to the support to enable simultaneous repositioning of the plurality of distinct design portions.

32. The member of claim 31, wherein the expanse is adapted to be moved relative to the support while remaining coupled to the support.

33. The member of claim 32, wherein the expanse is adapted to slide relative to the support.

34. The cover of claim 31, wherein the expanse is flexible.

35. The member of claim 34, wherein the expanse is sufficiently flexible so as to be adapted to wrap about a portion of the support and to extend in two substantially parallel planes.

36. The member of claim 31, wherein the plurality of distinct design portions are fixedly coupled to the expanse.

37. The member of claim 31, wherein the plurality of distinct design portions includes at least one raised portion.

38. The member of claim 31, wherein the plurality of distinct design portions includes a paint absorbing and releasing material.

39. The member of claim 31, wherein the expanse is endless.

40. The member of claim 31, wherein the expanse is adapted to be removably coupled to the support.
